(19) United States
(12) Patent Application Publication
(10) Pub. No.: US 2025/0045484 A1
(43) Pub. Date: Feb. 6, 2025

(54) SUPPORT SINK APPLICATION METHOD FOR 3D PRINTING HEAT DISSIPATION ANALYSIS

(71) Applicant: Korea Electronics Technology Institute, Seongnam-si (KR)

(72) Inventors: Hwa Seon SHIN, Yongin-si (KR); Jae Ho SHIN, Hanam-si (KR); Hye In LEE, Anyang-si (KR); Sung Hwan CHUN, Seoul (KR); Sung Hun PARK, Seoul (KR)

(73) Assignee: Korea Electronics Technology Institute, Seongnam-si (KR)

(21) Appl. No.: 18/720,200

(22) PCT Filed: Dec. 14, 2022
(86) PCT No.: PCT/KR2022/020291

§ 371 Date: Jun. 14, 2024

(30) Foreign Application Priority Data
Dec. 16, 2021 (KR) 10-2021-0180714

(51) Int. Cl. G06F 30/20; B29C 64/393; B33Y 50/02; G06F 113/10; G06F 119/08

(52) U.S. Cl. CPC G06F 30/20; B29C 64/393; B33Y 50/02; G06F 2113/10; G06F 2119/08

(57) ABSTRACT

A support sink application method for 3D printing heat dissipation analysis is provided. The support sink application method according to an embodiment of the present invention comprises the steps in which: a support sink application system adds a support sink in order to simulate heat dissipation using a support in a state where a support shape is not generated in a 3D model; the support sink application system performs heat dissipation simulation with the support sink added to the 3D model; and the support sink application system adjusts the support sink on the basis of the result of the simulation. Therefore, the convenience of heat dissipation simulation can be improved by introducing the support sink capable of representing heat dissipation by the support with no support shape. In addition, due to dependency reduction caused by a support change, it is not necessary to reanalyze a target model (shape) even when a support is added/moved/deleted, and thus the convenience of heat dissipation simulation can be improved.

### TECHNICAL FIELD

The disclosure relates to a metal three-dimensional (3D) printing technology, and more particularly, to a technology for performing layer analysis through a 3D printing heat dissipation simulation.

### BACKGROUND ART

In the case of metal 3D printing, supports may be used to dissipate heat generated when additive manufacturing is performed. Accordingly, when heat dissipation is simulated, supports should be included in a 3D model for calculation.

However, as supports are added in addition to a 3D model, a problem of an increasing amount of calculation may arise. In addition, since division and calculation for a model should be re-performed every time supports are moved, there may be difficulty in freely adding/moving/deleting supports.

### DISCLOSURE

### Technical Problem

The disclosure has been developed in order to address the above-discussed deficiencies of the prior art, and an object of the disclosure is to provide a support sink application method which can improve the convenience of heat dissipation simulation by introducing a support sink capable of representing heat dissipation by the support without generating a support shape.

### Technical Solution

According to an embodiment of the disclosure to achieve the above-described object, a support sink application method may include: a step of adding, by a support sink application system, a support sink in order to perform a heat dissipation simulation by a support in a state where a support shape is not generated in a 3D model; a step of performing, by the support sink application system, the heat dissipation simulation with the support sink being added to the 3D model; and a step of adjusting, by the support sink application system, the support sink, based on a result of performing the simulation.

The step of adjusting the support sink may include moving or deleting the support sink which is added before the heat dissipation simulation is performed, or adding a new support sink.

In addition, when heat dissipates from top to bottom and a base is placed on a bottom surface, the support sink may include a first support sink (body-to-body) which is connected from an upper body of the 3D model to a lower body to dissipate heat generated in the upper body to the lower body, and a second support sink (body-to-base) which is connected from the body of the 3D model to a lower base to dissipate heat generated in the body to the lower base.

According to an embodiment of the disclosure, the support sink application may further include a step of inputting information on a support through the support sink application system to add the support sink, and in this case, the step of inputting the information on the support may include inputting information on Length indicating a Z-axis direction length of the support and Surface Area indicating a surface area of the support contacting the 3D model.

In addition, the step of inputting the information on the support may include inputting information on an upper surface area and a lower surface area as the support is connected to the body of the 3D model or base at top and bottom when inputting the information on the surface area of the support.

In addition, the step of inputting the information on the support may include inputting information on each volume index to display a position at which the support contacts the body of the 3D model or the base when inputting the information on the length and the surface area of the support.

In addition, when the information on the lower surface area of the support is inputted, only a position at which the upper portion of the support contacts the body of the 3D model may be displayed on a screen.

The step of adding the support sink may include, when the support has a cylindrical shape and the information on the length and the surface area is inputted, calculating a volume by using the inputted length and surface area.

In addition, the step of inputting the information on the support may include, when a tip is provided at an end of the support or the support has other shapes than a cylindrical shape, inputting information on Volume indicating a volume occupied by the support when inputting the information on the length and the surface area of the support.

According to another embodiment of the disclosure, a support sink application system may include: an input unit configured to input information on a support; and a processor configured to add a support sink based on the information inputted through the input unit, to perform a heat dissipation simulation by the support with the support sink being added to a 3D model in a state where a support shape is not generated in the 3D model, and to adjust the support sink, based on a result of performing the simulation.

According to still another embodiment of the disclosure, a support sink application method may include: a step of inputting, by a support sink application system, information on Length indicating a Z-axis direction length of a support and Surface Area indicating a surface area of the support contacting a 3D model; a step of adding, by the support sink application system, a support sink based on the inputted information; a step of performing, by the support sink application system, a heat dissipation simulation by the support with the support sink being added to the 3D model in a state where a support shape is not generated in the 3D model; and a step of adjusting, by the support sink application system, the support sink, based on a result of performing the simulation.

According to yet another embodiment of the disclosure, a support sink application system may include: an input unit configured to input information on Length indicating a Z-axis direction length of a support and Surface Area indicating a surface area of the support contacting a 3D model in order to perform a heat dissipation simulation; and a processor configured to add a support sink based on the information inputted through the input unit, to perform the heat dissipation simulation by the support with the support sink being added to the 3D model in a state where a support shape is not generated in the 3D model, and to adjust the support sink, based on a result of performing the simulation.

### Advantageous Effects

As described above, according to embodiments of the disclosure, the convenience of heat dissipation simulation can be improved by introducing a support sink capable of representing heat dissipation by a support without generating a support shape

In addition, due to reduction of dependency caused by a support change, it is not necessary to reanalyze a target model (shape) even when a support is added/moved/deleted, and thus the convenience of heat dissipation simulation can be improved.

### DESCRIPTION OF DRAWINGS

FIG. 1 is a view illustrating a screen showing a result of volumizing supports which are included in a 3D model;

FIG. 2 is a view illustrating a screen showing a result of performing a heat dissipation simulation based on volumization;

FIG. 3 is a view illustrating a screen showing a 3D model without supports;

FIG. 4 is a view illustrating a result of volumizing the 3D model shown in FIG. 3;

FIG. 5 is a view illustrating a support sink which is added to a 3D model according to an embodiment of the disclosure;

FIG. 6 is a view illustrating a screen showing a result of simulating based on the support sink shown in FIG. 5;

FIG. 7 is a view illustrating a real support sink which is created based on the support sink of FIG. 5;

FIG. 8 is a view provided to explain a support sink application method according to an embodiment of the disclosure;

FIG. 9 is a view provided to explain two types of support sinks according to an embodiment of the disclosure;

FIG. 10 is a view provided to explain three key elements of a support sink according to an embodiment of the disclosure; and

FIG. 11 is a view provided to explain a support sink application system according to an embodiment of the disclosure.

### BEST MODE

Hereinafter, the disclosure will be described in more detail with reference to the drawings.

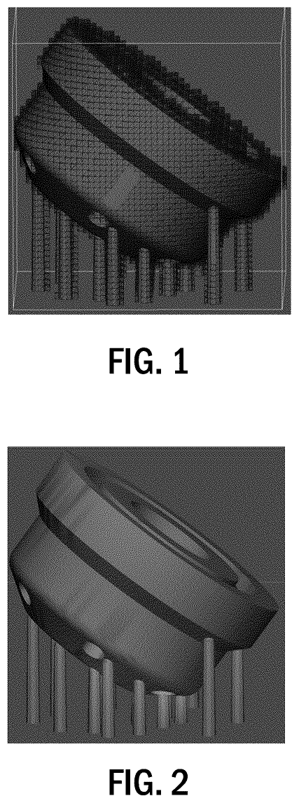

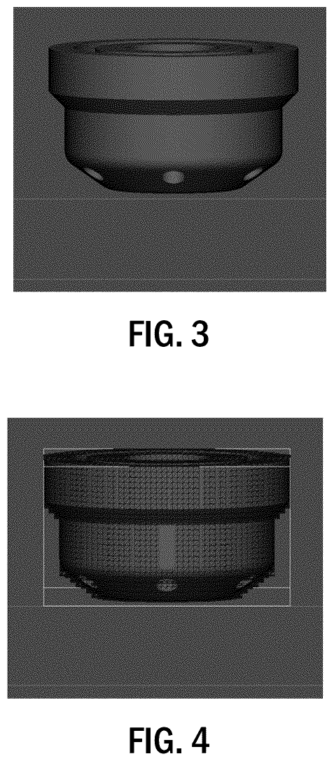

FIG. 1 is a view illustrating a screen showing a result of volumizing supports which are included in a 3D shape (model), FIG. 2 is a view illustrating a screen showing a result of performing a heat dissipation simulation based on volumization, FIG. 3 is a view illustrating a screen showing a 3D model without supports, and FIG. 4 is a view illustrating a result of volumizing the 3D model shown in FIG. 3.

Current simulation technologies require a process of dividing a 3D shape into cubes (or cuboids), which is referred to as volumization.

A support sink application method according to an embodiment may perform volumization with respect to only an original model without adding supports, and may add a support sink to the 3D model for which volumization has been performed.

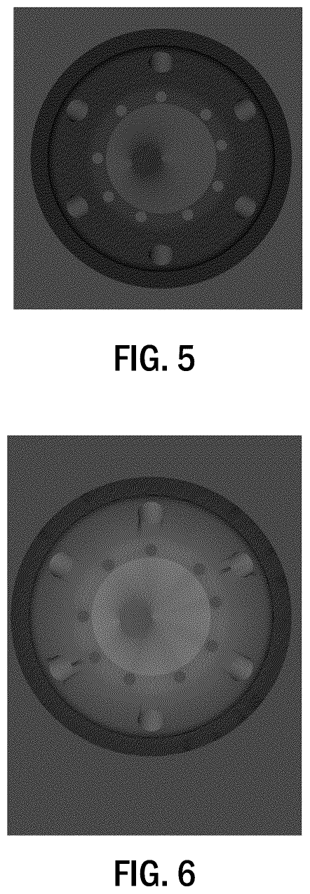

FIG. 5 is a view illustrating a support sink which is added to a 3D model according to an embodiment of the disclosure, and FIG. 6 is a view illustrating a screen showing a result of simulating based on the support sink shown in FIG. 5.

In the 3D model shown in FIGS. 5 and 6, a shape expressed by circles indicate support sinks. Here, surroundings of the support sink are expressed by green color, which is different from the color of outside, red color. In this case, the green color indicates a lower temperature than the temperature indicated by red color.

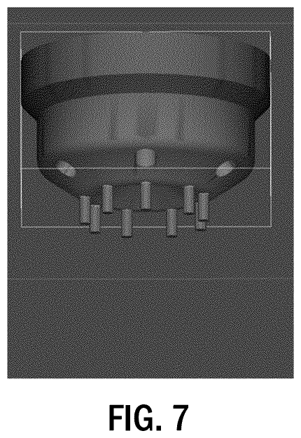

FIG. 7 is a view illustrating a real support sinks which are created based on the support sink shown in FIG. 5. In FIG. 7, a support shape is not included in a simulation and is expressed as having no change in color.

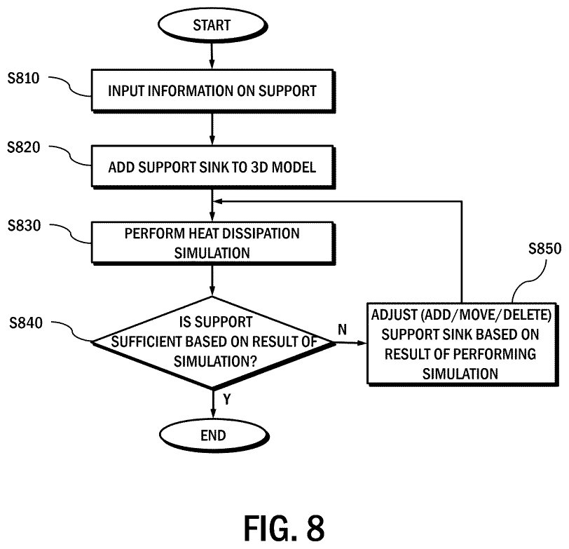

That is, the support sink application method according to an embodiment may perform a heat dissipation simulation by supports in a state where a support shape is not generated, and hence, due to reduction of dependency caused by a support change, it is not necessary to reanalyze a target model (shape) even when a support is added/moved/deleted. This will be described in detail with reference to FIG. 8.

FIG. 8 is a view provided to explain a support sink application method according to an embodiment of the disclosure.

Referring to FIG. 8, when information on a support is inputted through a support sink application system to add a support sink (S810), the support sink application method according to an embodiment may add a support sink to simulate heat dissipation by the support in a state where a support shape is not generated (S820), may perform a heat dissipation simulation with the support sink being added to the 3D model (S830), and may determine whether the support is sufficient based on the result of the simulation (S840).

Specifically, when it is determined that the support is not sufficient (S840-N), the support sink application method may repeat an operation of adjusting the support sink based on the result of the simulation (S850).

That is, the support sink application method may adjust the support sink based on the result of performing the heat dissipation simulation, and may repeat the operations of performing the heat dissipation simulation and then adjusting the support sink, so that a nonskilled person can efficiently guarantee an optimized heat dissipation simulation result.

To achieve this, the support sink application method may receive input of information on Length indicating a Z-axis direction length of the support and Surface Area indicating a surface area of the support contacting the 3D model in the process of receiving input of information on the support.

The support sink application method may move or delete the support sink that is added before the heat dissipation simulation is performed, or may add a new support sink when adjusting the support sink.

For example, the support sink application method may identify the result of performing the heat dissipation simulation, and may add a support sink to a place of a very high temperature when adjusting the support sink, and then, may perform the simulation again, and may identify the result therefrom and may add a support sink or delete an existing support sink.

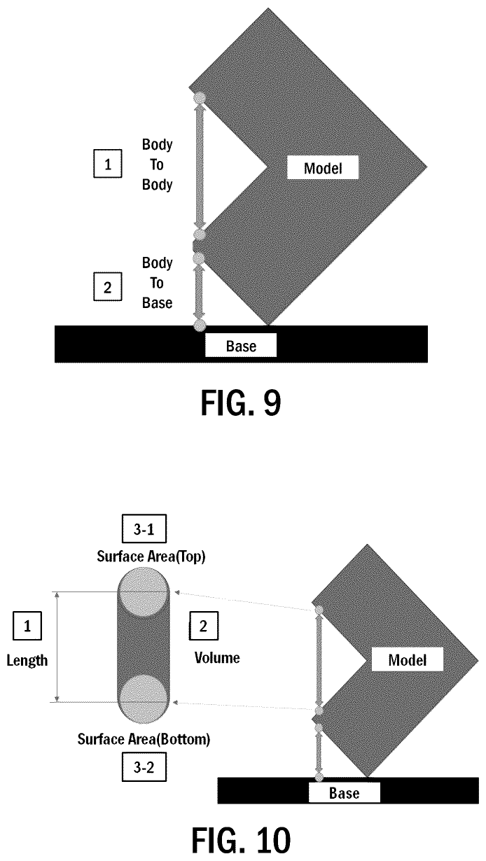

FIG. 9 is a view provided to explain two types of support sinks according to an embodiment of the disclosure.

According to an embodiment, support sinks are expressed by circles in a 3D model when support sinks are connected to a body of the 3D model or a base at top and bottom in order to indicate heat dissipation by the support in a state where a support shape is not generated.

Referring to FIG. 9, when heat dissipates from top to bottom and the base is placed on a bottom surface, the support sinks may be divided into two types as the support sinks are connected to the body of the 3D model or the base at top and bottom, respectively.

Specifically, when heat dissipates from top to bottom and the base is placed on a bottom surface, the support sinks may be divided into a first support sink (body-to-body) which is connected from an upper body of the 3D model to a lower body, and a second support sink (body-to-base) which is connected from the body of the 3D model to the lower base.

When heat dissipates from top to bottom and the base is placed on a bottom surface, the first support sink may be connected from the upper body of the 3D model to the lower body to dissipate heat generated in the upper body to the lower body.

When heat dissipates from top to bottom and the base is placed on a bottom surface, the second support sink may be connected from the body of the 3D model to the lower base to dissipate heat generated in the body to the lower base.

FIG. 10 is a view provided to explain three key elements of a support sink according to an embodiment of the disclosure.

The support sink according to an embodiment may have three key elements which are necessary for performing a heat dissipation simulation.

Specifically, the three key elements of the support sink may include Length indicating a Z-axis direction length of a support, Volume indicating a volume occupied by the support, and Surface Area indicating a surface area of the support contacting a 3D model. In this case, the three key elements may be expressed by LVS which is initials of each word.

When a support has a cylindrical shape and information on Length indicating a Z-axis direction length of the support and Surface Area indicating a surface area of the support contacting a 3D model is inputted in the process of inputting information on the support, the support sink application method according to an embodiment may calculate a volume by using the length and the surface area inputted in a process of adding a support sink.

In addition, when information on the surface area of the support is inputted, the support sink application method may input information on an upper surface area and a lower surface area as the support is connected to the body of the 3D model or the base at top and bottom.

In this case, when information on the lower surface area of the support is inputted, only a position at which the upper portion of the support contacts the body of the 3D model may be displayed on a screen in the shape of a circle in the 3D model.

When a tip is provided at an end of the support or the support is formed in other shapes than the cylindrical shape, in order to add a support sink and perform a heat dissipation simulation, the support sink application method should input information on all of Length indicating a Z-axis direction length of the support, Volume indicating a volume occupied by the support, and Surface Area indicating a surface area of the support contacting the 3D model in the process of inputting information on the support.

In addition, when information on the length and the surface area of the support is inputted, the support sink application method may also input information on each volume index in order to display a position where the support contacts the body of the 3D model or the base as shown in FIG. 10.

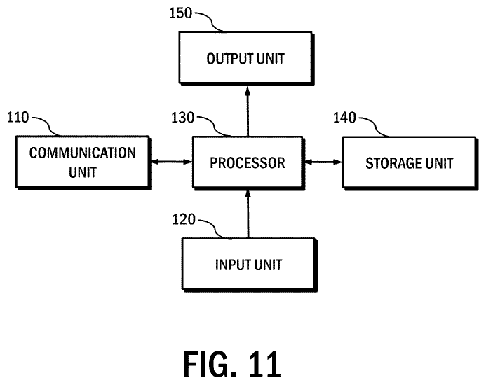

FIG. 11 is a view provided to explain a support sink application system according to an embodiment of the disclosure.

The support sink application system according to an embodiment may be provided to execute the support sink application method described above with reference to FIGS. 1 to 10.

To achieve this, the support sink application system according to an embodiment may include a communication unit 110, an input unit 120, a processor 130, a storage unit 140, and an output unit 150.

The communication unit 110 is a means for communicating with external devices including a 3D printer and accessing a server, a cloud, etc. through a network, and may transmit/receive/upload/download data necessary for a heat dissipation simulation of a 3D model and 3D printing.

The input unit 120 may be provided to input information on a support.

For example, the input unit 120 may input information on Length indicating a Z-axis direction length of a support and Surface Area indicating a surface area of the support contacting the 3D model in order to add a support sink.

In addition, the input unit 120 may input information for moving an existing support sink or adding a new support sink even in a process of adjusting the support sink based on a result of performing a simulation.

The processor 130 may add a support sink based on information inputted through the input unit 120, may perform a heat dissipation simulation by a support with the support sink being added to the 3D model in a state where a support shape is not generated in the 3D model, and may adjust the support sink based on the result of performing the simulation.

The storage unit 140 is a storage medium that stores a program and data necessary for operating the processor, and the output unit 150 is a display that outputs information generated/processed by the processor 130 on a screen. For example, the output unit 140 may output a 3D model to which a support sink is added, and a result of performing a heat dissipation simulation of the 3D model on the screen.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. A support sink application method comprising:
a step of adding, by a support sink application system, a support sink in order to perform a heat dissipation simulation by a support in a state where a support shape is not generated in a 3D model;
a step of performing, by the support sink application system, the heat dissipation simulation with the support sink being added to the 3D model; and
a step of adjusting, by the support sink application system, the support sink, based on a result of performing the simulation.

2. The support sink application method of claim 1, wherein the step of adjusting the support sink comprises moving or deleting the support sink which is added before the heat dissipation simulation is performed, or adding a new support sink.

3. The support sink application method of claim 2, wherein, when heat dissipates from top to bottom and a base is placed on a bottom surface, the support sink comprises a first support sink (body-to-body) which is connected from an upper body of the 3D model to a lower body to dissipate heat generated in the upper body to the lower body, and a second support sink (body-to-base) which is connected from the body of the 3D model to a lower base to dissipate heat generated in the body to the lower base.

4. The support sink application method of claim 3, further comprising a step of inputting information on a support through the support sink application system to add the support sink,
wherein the step of inputting the information on the support comprises inputting information on Length indicating a Z-axis direction length of the support and Surface Area indicating a surface area of the support contacting the 3D model.

5. The support sink application method of claim 4, wherein the step of inputting the information on the support comprises inputting information on an upper surface area and a lower surface area as the support is connected to the body of the 3D model or base at top and bottom when inputting the information on the surface area of the support.

6. The support sink application method of claim 5, wherein the step of inputting the information on the support comprises inputting information on each volume index to display a position at which the support contacts the body of the 3D model or the base when inputting the information on the length and the surface area of the support.

7. The support sink application method of claim 5, wherein, when the information on the lower surface area of the support is inputted, only a position at which the upper portion of the support contacts the body of the 3D model is displayed on a screen.

8. The support sink application method of claim 4, wherein the step of adding the support sink comprises, when the support has a cylindrical shape and the information on the length and the surface area is inputted, calculating a volume by using the inputted length and surface area.

9. The support sink application method of claim 4, wherein the step of inputting the information on the support comprises, when a tip is provided at an end of the support or the support has other shapes than a cylindrical shape, inputting information on Volume indicating a volume occupied by the support when inputting the information on the length and the surface area of the support.

10. A support sink application system comprising:
an input unit configured to input information on a support; and
a processor configured to add a support sink based on the information inputted through the input unit, to perform a heat dissipation simulation by the support with the support sink being added to a 3D model in a state where a support shape is not generated in the 3D model, and to adjust the support sink, based on a result of performing the simulation.

11. A support sink application method comprising:
a step of inputting, by a support sink application system, information on Length indicating a Z-axis direction length of a support and Surface Area indicating a surface area of the support contacting a 3D model;
a step of adding, by the support sink application system, a support sink based on the inputted information;
a step of performing, by the support sink application system, a heat dissipation simulation by the support with the support sink being added to the 3D model in a state where a support shape is not generated in the 3D model; and
a step of adjusting, by the support sink application system, the support sink, based on a result of performing the simulation.

12. A support sink application system comprising:
an input unit configured to input information on Length indicating a Z-axis direction length of a support and Surface Area indicating a surface area of the support contacting a 3D model in order to perform a heat dissipation simulation; and
a processor configured to add a support sink based on the information inputted through the input unit, to perform the heat dissipation simulation by the support with the support sink being added to the 3D model in a state where a support shape is not generated in the 3D model, and to adjust the support sink, based on a result of performing the simulation.
